(19) United States
(12) Patent Application Publication
(10) Pub. No.: US 2008/0231949 A1
(43) Pub. Date: Sep. 25, 2008

(54) Relay Set for a Rigid Endoscope

(75) Inventor: Takao Mori, Tokyo (JP)

Correspondence Address: RANKIN, HILL & CLARK LLP, 38210 Glenn Avenue, WILLOUGHBY, OH, 44094-7808, US

(73) Assignee: OLYMPUS WINTER & IBE GMBH, Hamburg (DE)

(21) Appl. No.: 10/597,501

(22) PCT Filed: Feb. 13, 2004
(86) PCT No.: PCT/EP2004/001337

§ 371 Date: Jul. 27, 2006

(51) Int. Cl. G02B 23/24

(52) U.S. Cl. 359/435

(57) ABSTRACT

A relay set (1, 11, 23) for the optical system of a rigid endoscope, the optical system comprising an objective (20) at the distal end, an ocular (22) at the proximal end and between them a relay lens system consisting of several relay sets (1, 11, 21, 23), the relay set (1, 11, 23) consisting of two half sets (2a, 2b) having the same lens units (3a1, 3a2, 3a3, 3a4; 3b1, 3b2, 3b3, 3b4) arranged in symmetrical sequence with respect to the center (5) of the set, wherein each half set (2a, 2b) consists of four lens units (3a1, 3a2, 3a3, 3a4; 3b1, 3b2, 3b3, 3b4) having in the sequence of raising distance from the center (5) the refracting powers Positive, Negative, Positive, Positive (P, N, P, P).

### BACKGROUND OF THE INVENTION

Rigid endoscopes usually have an optical system consisting of an objective, an ocular and between them a relay lens system consisting of several relay sets. Because the objective and each relay set is producing an image which is turned up-side down, and because a standard endoscope should produce an upright image, usually an odd number of relay sets is used so that the image produced by the optical system is upright.

Generic relay sets, as shown in U.S. Pat. No. 4,676,606 and U.S. Pat. No. 4,693,568, have a symmetrical arrangement of lens units so that the relay set is consisting of two symmetric half sets.

Known relay sets have the disadvantage that they need highly complicated calculations to design a relay set with desired optical properties, i.e. with corrected lens aberrations. If a relay set is correctly designed, it has a fixed configuration and it is mass produced in this configuration to be used several times in an optical system.

The disadvantage of the relay set, according to the state of the art, is that according to its fixed configuration it also has a fixed overall length. This means that an optical system; at reasonable costs, can only be produced having a length that is a multiple (normally odd multiple) of the length of the relay set. If a standard resectoscope has three relay sets and a longer resectoscope is needed, it is necessary to use five relay sets so that the overall length of the ocular is almost double. If an only slightly elongated endoscope is needed, a relay set with a length other than the standard length is needed and has to be completely redesigned. Such a complete redesign of a relay set is extremely complicated and expensive.

### BRIEF SUMMARY OF THE INVENTION

The objective of the present invention is to make the design of endoscope with different lengths easier and less expensive.

According to the invention, the lens units in each half set of the relay set and seen from the center are having the following refractive power (Positive and Negative in the following are called P and N): P,N,P,P. For the complete relay set this is P,P,N,P, (center), P,N,P,P. To make a relay set according to the state of the art with a new length, requires a complete recalculation of all distances of the lens units and also of the lens units themselves. Quite to the contrary, according to the invention a recalculation of the overall length of the relay set requires only finding new distances of the lens units. No changes with the lens units themselves are necessary. The correction of lens aberrations remains unaffected by the change of overall length. With the same set of lens units, using only different distances, a new overall length of the relay set can be achieved. Finding the correct placement of the lens units for a new overall length of the relay set is quite simple. For a given set of lens units simple formulas or curves can be given according to which all the places of the lens units for a desired overall length easily can be found. With the relay set according to the invention, therefore, it is an easy design step to change the overall length of the set. If an endoscope with a special overall length is needed, the invention allows for the simple design of relay sets of an appropriate length. The relay set according to the invention can be mixed in an optical system with conventional relay sets. If a given endoscope having three conventional relay sets each 60 mm long, has to be made 10 cm longer, one additional conventional relay set and one relay set according to the invention with a length of 40 mm can be added.

It is advantageous to have the corresponding lens units of the two half sets at symmetrical distances from the center. With this design the magnification of the lens unit is 1 as it is generally required.

Having the outer lenses in an asymmetrical position, the magnification is different from 1. The advantages of previous embodiments of the invention with respect to easy calculation of the overall length remain also with this embodiment.

It is advantageous to place a glass rod in the middle of the relay set. This is a well known measure to reduce the air length.

### BRIEF DESCRIPTION OF THE DRAWINGS

In the drawings examples of the invention are schematically shown.

FIGS. 1a-d show the arrangement of the lens units of a relay set in four different overall lengths;

FIGS. 2a-c show the lens units of a relay set having the same length but three different magnifications;

FIG. 3 shows a conventional optical system with three conventional relay sets; and

FIGS. 4a-c show an optical system having four conventional relay sets and one relay set according to the invention in three different lengths.

### DETAILED DESCRIPTION OF THE INVENTION

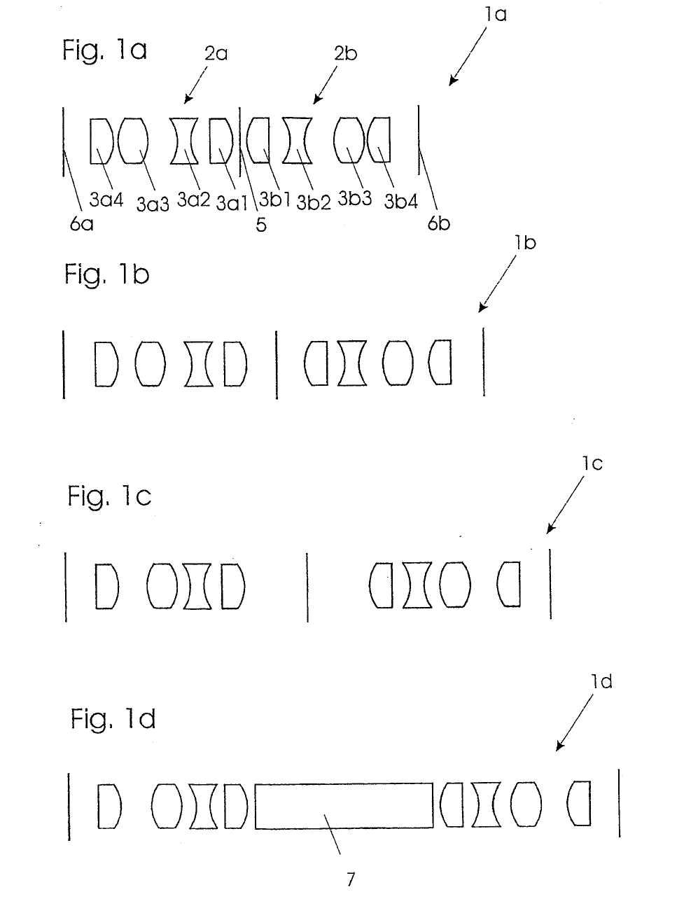

FIGS. 1a-d show relay sets according to the invention in different lengths.

In FIG. 1a, a relay set 1a is shown which, according to the invention, has two half sets 2a and 2b being symmetrically arranged with respect to the center of the relay set 1 which in the drawing is indicated by a center line 5. From the center line 5 to the outside, the half set 2a has lens units 3a1, 3a2, 3a3 and 3a4. The half set 2b has lens units 3b1, 3b2, 3b3 and 3b4. The lenses of the pairs 3a1-3b1, 3a2-3b2, 3a3-3b3 and 3a4-3b4 are identical and are symmetrically placed with respect to the center line 5. According to the invention, the refractive powers of the lens units are: 3a1 and 3b1 positive, 3a2 and 3b2 negative, 3a3 and 3b3 positive and 3a4 and 3b4 positive. This is indicated with the letters P and N underneath FIG. 1a.

To the left and to the right of the relay set 1a image planes 6a and 6b are shown. Because of its symmetrical arrangement, the relay set 1 is transporting an image from 6a to 6b or vice versa with the magnification 1.

In FIG. 1, the relay set 1a is shown with a certain overall length.

In FIG. 1b and in FIG. 1c, relay sets 1b and 1c are shown having different overall lengths. As can be seen from FIG. 1, for all three lens sets 1a, 1b and is exactly the same lens units are used. Only their relative distances from the center line 5 are varied. In all three configurations the magnification is 1. Only the overall length is different. Also the correction of lens aberrations remains the same. All major lens aberrations are sufficiently corrected.

If the relay set 1a is correctly designed in one overall length as shown in FIG. 1a, the variation of overall length is easily achieved. As can be seen from FIGS. 1a to 1c, the variation of lens positions follows simple relations.

The lens units 3a1 to 3b4 do not require any redesign. According to the invention, it is only necessary to have the lens units chosen with proper refractive power, namely 3a1 and 3b1 with positive power, 3a2 and 3b2 with negative power, 3a3 and 3b3 with positive power and 3a4 and 3b4 with positive power.

Following the before mentioned rule, the lens units can vary in shape from the embodiment shown in FIGS. 1a to 1c. Instead of the simple lenses shown in the drawing lens units of cemented type, composed of several different glasses can also be used.

FIG. 1d shows an alternative relay set 1d. The lenses 3a1 to 3a4 and 3b1 to 3b4 are the same as with 1a. In the center gap between lenses 3a1 and 3b1, a glass rod 7 with parallel end faces is placed in order to reduce in the big center gap between the half-sets 2a and 2b, the distance through which the light has to travel through air.

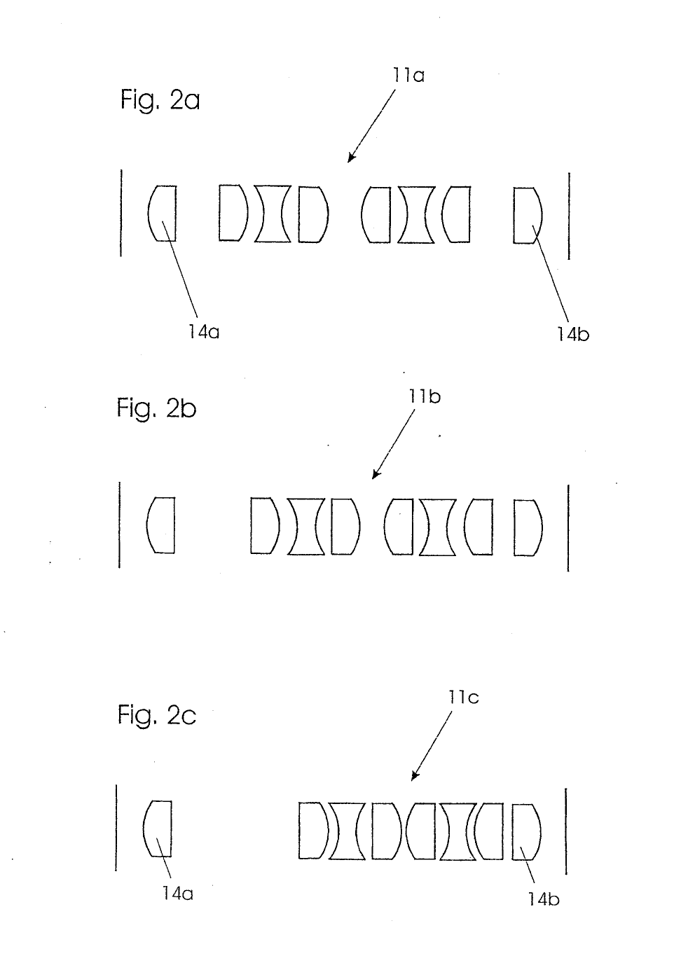

According to FIGS. 1a to 1d, the arrangement of lenses in the two half sets 2a and 2b is symmetrical with respect to the center line 5. Due to this symmetrical arrangement of lens units the magnification of the relay sets 1a to 1c is 1. An alternative possibility is shown in FIG. 2.

FIG. 2a shows a relay set 11a having a similar design as relay set 1a of FIG. 1a. According to the invention, is the relay set 11a again has a symmetrical arrangement of lens units with a sequence of refractive power P,N,P,P in each half set.

FIG. 2b shows a relay set 11b using exactly the same lens units as in relay set 11a. As shown in FIG. 2, the overall length of relay set 11a and relay set 11b are the same. But in the relay set 11b, the outermost lenses 14a and 14b are shifted asymmetrically. Due to this asymmetrical arrangement of lenses the magnification is different. In this case it is 0.75.

FIG. 2c shows relay set 11c again having the same lenses as relay set 11a. The outermost lenses 14a and 14b, as can be seen in FIG. 2c, even more shifted asymmetrically as with lens unit 11b. The overall length again is the same as that of the relay sets 11a and 11b. The magnification of the relay set 11c is 0.5. It has to be remarked that in the examples shown in FIGS. 2a to 2c, the magnifications given as 1 for FIG. 2a, 0.75 for FIG. 2b and 0.5 for FIG. 2c, are valid for rays passing the lens units from left to right. If the light goes from right to left the magnifications are 1 in FIG. 2a, 1.33 for FIGS. 2b and 2 for FIG. 2c.

The relay sets 11a, 11b and 11c of FIG. 2 have the same advantage as the lens unit 1 shown in FIG. 1 with respect to the possibility to easily change the overall length.

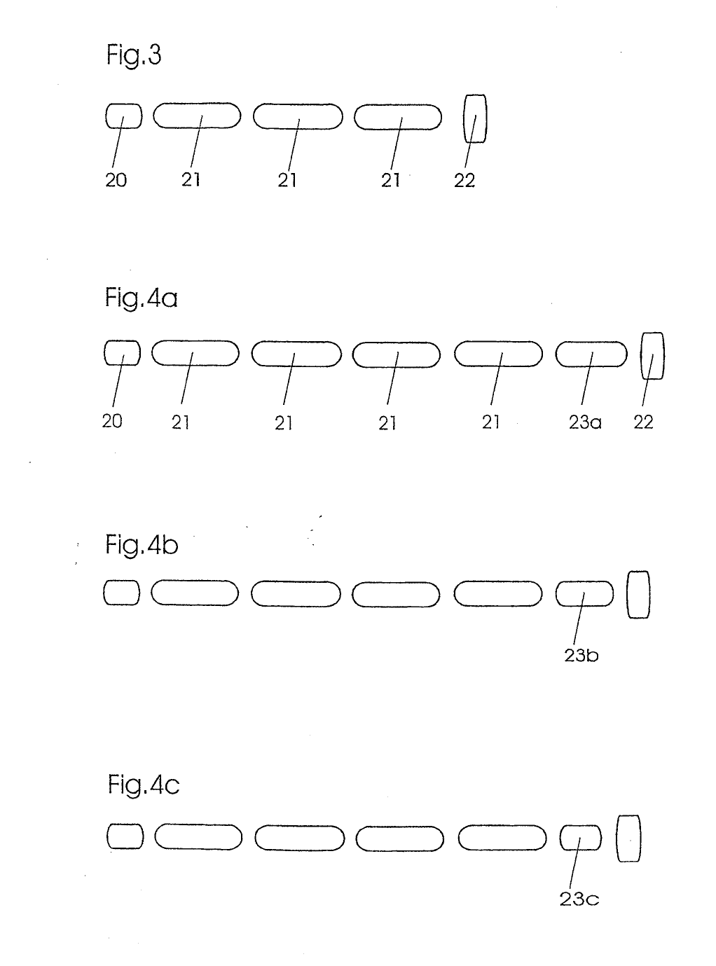

The relay sets shown in FIGS. 1 and 2 are used in rigid endoscopes as shown, for example, in FIG. 13 of U.S. Pat. No. 4,693,568. According to the standard design of rigid endoscopes, a rigid metal tube, not shown, is enclosing an optical system as shown in FIG. 3.

The optical system of FIG. 3 is of a conventional design having an objective 20, three relay sets 21 and an ocular 22. The relay sets 21 are identical. They may be of any conventional design according to the state of the art as mentioned in the introduction. To keep the image upright, the number of relay sets 21 is odd.

If a longer endoscope is needed, additional relay sets can be added. This is shown in FIG. 4a. To the right of the optical system, two additional relay sets are added. One of them is another conventional relay set 21. The other one is a relay set 23a designed according to the present invention, e.g. a relay set as shown in FIG. 1 or 2. As can be seen from FIG. 4a, the relay set 23a is shorter than the relay set 21 so that a desired specific overall length of the endoscope results. As shown in FIGS. 4b and 4c, relay sets 23b or 23c of different lengths can replace 23a so that any required overall length of the endoscope is possible.

Additionally, it is possible to replace any of the conventional relay sets 21 by a relay set 23a, according to the present invention, so that the overall length of the endoscope can be adjusted to any required length. For special purposes, a relay set according to FIG. 2, having a magnification smaller or bigger than 1, can be used.

1. A relay set (1,11, 23) for the optical system of a rigid endoscope, said optical system comprising
an objective (20) at a distal end;
an ocular (22) at a proximal end; and
between the objective (20) and ocular (22), a relay lens system consisting of several relay sets (1,11, 21,23), said relay set (1,11, 23) consisting of two half sets (2a, 2b) having the same lens units (3a1, 3a2,3a3, 3a4; 3b1, 3b2, 3b3,3b4) arranged in symmetrical sequence with respect to the center (5) of the set, wherein each half set (2a, 2b) consists of four lens units (3a1, 3a2,3a3, 3a4; 3b1, 3b2,3b3, 3b4) having, in the sequence of raising distance from the center (5), the refracting powers Positive, Negative, Positive, Positive (P, N, P, P).

2. The relay set according to claim 1, wherein the pairs (3a1-3b1, 3a2-3b2,3a3-3b3, 3a4-3b4) of corresponding lens units of the half sets (2a, 2b) are arranged at symmetrical distances from the center (5).

3. The relay set according to claim 1, wherein outermost lens units (14a, 14b) of the half sets (2a, 2b) are arranged at asymmetrical distances from the center (5).

4. The relay set according to claim 1, wherein in the gap between the half sets (2a, 2b), a glass rod (7) with parallel end faces is placed.
